(19) United States
(12) Patent Application Publication
(10) Pub. No.: US 2022/0138773 A1
(43) Pub. Date: May 5, 2022

(54) System and Method of Identifying and Analyzing Significant Changes in User Ratings

(71) Applicant: MICROSOFT TECHNOLOGY LICENSING, LLC, Redmond, WA (US)

(72) Inventors: Manoj Kumar RAWAT, Bellevue, WA (US); Orens XHAGOLLI, Redmond, WA (US); Sathia Prabhu THIRUMAL, Bothell, WA (US)

(73) Assignee: MICROSOFT TECHNOLOGY LICENSING, LLC, Redmond, WA (US)

(21) Appl. No.: 17/085,377

(22) Filed: Oct. 30, 2020

(51) Int. Cl. G06Q 30/02; G06F 17/18

(52) U.S. Cl. CPC G06Q 30/0201; G06Q 30/0282; G06Q 30/0205; G06F 17/18

(57) ABSTRACT

A method and system for identifying statistically significant changes in user ratings includes receiving a request to identify a statistically significant change in a parameter associated with changes in user ratings between a first time period and a second time period, retrieving data from a first data structure associated with the user ratings during the first time period and a second data structure associated with the user ratings during the second time period, each of the first and the second data structures including a plurality of dimensions for each user rating and each dimension having one or more levels, identifying, based on the retrieved data, the statistically significant change in the parameter between the first time period and the second time period, identifying a dimension and a level associated with the identified statistically significant change, and providing display data for generating a user interface (UI) screen to display information about the identified statistically significant change.

### CROSS-REFERENCE TO A RELATED APPLICATION

This patent application is related to co-pending, commonly-owned U.S. patent application Ser. No. (not yet assigned) entitled “System and Method of Analyzing Changes in User Ratings,” filed concurrently herewith under Attorney Docket No. 408950-US-NP/170101-673, which is incorporated herein by reference in its entirety.

### TECHNICAL FIELD

This disclosure relates generally to multidimensional analysis of changes in user ratings, and, more particularly, to a method of and system for analyzing statistically significant changes in user ratings over multiple dimensions.

### BACKGROUND

Enterprises often rely on user ratings to measure customer satisfaction and identify areas for improvement. One of the most commonly utilized user rating schemes is the Net Promotor Score (NPS). The NPS offers a simple mechanism for measuring customer satisfaction. To calculate the NPS, users are offered a rating scale (e.g., a scale of 0 to 5 or a scale of 0 to 10) to rate a company, service, or product. The rating is representative of the likelihood of the user recommending the company, service or product to another person. To calculate the NPS, the percentage of users that are unlikely to recommend the company, service or produce (e.g., those providing a rating score of 0 to 6 on a scale of 0 to 10) is deducted from the percentage of users that are highly likely to promote the company, service or product (e.g. those with scores of 9 or 10 on a scale of 0 to 10).

In addition to reviewing the recent NPS scores, it is sometimes useful for enterprises to monitor how user ratings change over time. To achieve this, changes in NPS within different time periods may be calculated and monitored. The changes may then be used to assess how recent changes (e.g., new product features, new locations, and the like) have affected customer satisfaction, which direction the market is moving towards, and the like. In addition to monitoring and analyzing an overall change in user ratings, it is often useful to identify significant changes in the user ratings and those changes that may relate to specific categories of users.

However, user ratings are often categorized into numerous different categories, each of which may have many underlying subcategories. As a result, determining significant changes in user ratings for one or more categories or subcategories can quickly turn into a cumbersome process which may involve complex and lengthy calculations requiring significant time and/or processing bandwidth.

Hence, there is a need for systems and methods of quickly and efficiently identifying and analyzing significant changes in user ratings over multiple categories.

### SUMMARY

In one general aspect, disclosed herein is a data processing system having a processor and a memory in communication with the processor wherein the memory stores executable instructions that, when executed by the processor, cause the data processing system to perform multiple functions. The functions may include receiving a request to identify a statistically significant change in a parameter associated with changes in user ratings between a first time period and a second time period, retrieving data from a first data structure associated with the user ratings during the first time period and a second data structure associated with the user ratings during the second time period, each of the first and the second data structures including a plurality of dimensions for each user rating and each dimension having one or more levels, identifying, based on the retrieved data, the statistically significant change in the parameter associated with the user ratings between the first time period and the second time period, identifying at least a dimension and a level associated with the identified statistically significant change, and providing display data for generating a user interface (UI) screen to display information about the identified statistically significant change. Identifying the statistically significant change in the parameter associated with the user ratings between the first time period and the second time period may include receiving, as an input, the first data structure, the second data structure and an integer number associated with a complexity level of calculations, calculating a margin of error for the first data structure and the second data structure, calculating the parameter associated with the changes in user ratings, identifying one or more results based on the parameter or the margin of error, sorting the one or more results, selecting statistically significant results from the sorted one or more results, resulting in a list of one or more remaining results, selecting the integer number of results from a top of the one or more remaining results, and repeating the selecting steps for a predetermined number of times.

In yet another general aspect, the instant application describes a method for identifying statistically significant changes in user ratings. The method may include receiving a request to identify a statistically significant change in a parameter associated with changes in user ratings between a first time period and a second time period, retrieving data from a first data structure associated with the user ratings during the first time period and a second data structure associated with the user ratings during the second time period, each of the first and the second data structures including a plurality of dimensions for each user rating and each dimension having one or more levels, identifying, based on the retrieved data, the statistically significant change in the parameter associated with the user ratings between the first time period and the second time period, identifying at least a dimension and a level associated with the identified statistically significant change, and providing display data for generating a UI screen to display information about the identified statistically significant change. Identifying the statistically significant change in the parameter associated with the user ratings between the first time period and the second time period may include receiving, as an input, the first data structure, the second data structure and an integer number associated with a complexity level of calculations, calculating a margin of error for the first data structure and the second data structure, calculating the parameter associated with the changes in user ratings, identifying one or more results based on the parameter or the margin of error, sorting the one or more results, selecting statistically significant results from the sorted one or more results, resulting in a list of one or more remaining results, selecting the integer number of results from a top of the one or more remaining results, and repeating the selecting steps for a predetermined number of times.

In a further general aspect, the instant application describes a non-transitory computer readable medium on which are stored instructions that when executed cause a programmable device to receive a request to identify a statistically significant change in a parameter associated with changes in user ratings between a first time period and a second time period, retrieve data from a first data structure associated with the user ratings during the first time period and a second data structure associated with the user ratings during the second time period, each of the first and the second data structures including a plurality of dimensions for each user rating and each dimension having one or more levels, identify, based on the retrieved data, the statistically significant change in the parameter associated with the user ratings between the first time period and the second time period, identify at least a dimension and a level associated with the identified statistically significant change, and provide display data for generating a UI screen to display information about the identified statistically significant change. Identifying the statistically significant change in the parameter associated with the user ratings between the first time period and the second time period may include receiving as an input the first data structure, the second data structure and an integer number associated with a complexity level of calculations, calculating a margin of error for the first data structure and the second data structure, calculating the parameter associated with the changes in user ratings, identifying one or more results based on the parameter or the margin of error, sorting the one or more results, selecting statistically significant results from the sorted one or more results, resulting in a list of one or more remaining results, selecting the integer number of results from a top of the list of one or more remaining results, and repeating the selecting steps for the selected one or more results.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 is an example data set used for collecting and storing NPS data in a given time period.

FIG. 3 is an example graphical user interface (GUI) screen of a data analysis application used to analyze and display customer rating data.

FIG. 4 is an example GUI screens for displaying information about statistically significantly changes in user ratings.

FIG. 5 is an example GUI screen for displaying information about the identified statistically significant change on a graphical diagram.

FIG. 6 is a flow diagram depicting an example method for identifying statistically significant changes in user rating and displaying information about such statistically significant change changes.

FIG. 7 is a block diagram illustrating an example software architecture, various portions of which may be used in conjunction with various hardware architectures herein described.

FIG. 8 is a block diagram illustrating components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

User rating mechanisms such as the NPS are widely used by enterprises to measure customer satisfaction. Once user rating data such as the NPS is collected and/or calculated, the data can be studied to evaluate customer satisfaction changes over time. Furthermore, the data can be examined to identify statistically significant changes in user ratings. Statistically significant changes may refer to changes in user rating data that are not explainable by chance alone (e.g., changes that are not likely to have occurred as a result of sampling error alone). Identifying such statistically significant changes may be important for enterprises because they may point to significant shifts in customer satisfaction. Thus, by detecting such statistically significant changes, enterprises may be able to quickly and efficiently identify issues that they may need to address or recognize factors that may have contributed towards a positive shift in customer satisfaction. As a result, detecting statistically significant changes in NPS may be used in making consequential business decisions.

Most enterprises offer surveys and collect user rating data from numerous users (e.g., thousands or millions). In order to evaluate the user rating data, additional information associated with each respondent may be collected from the users. The resulting data structure may be significantly large and complex. For example, the user data may be categorized according to numerous dimensions. To manually identifying statistically significant changes in user rating data in such data structures would require the exploring different filter combinations (e.g., two or more dimensions) one by one. However, the number of possible filter combinations where statistically significant changes can exist grows exponentially as the number of dimensions increases. For a user rating data structure having multiple dimensions, this can quickly become a very labor, memory and processing power and time-consuming effort. Thus, there exists a technical problem of identifying statistically significant changes in user rating efficiently and accurately.

To address these technical problems and more, in an example, this description provides a technical solution for analyzing changes in NPS in multiple different customer dimensions and levels, providing a user interface (UI) that enables a user to explore NPD for different dimensions and levels, and identifying and/or displaying dimensions and/or levels where changes in sample population caused NPS changes. To do so, techniques may be used to collect and take into account additional information about users (and/or their devices or products) that respond to a survey. The additional information may be used to categorize the users into different categories. These categories may be referred to as dimensions. In an example, the dimensions include customer type (e.g., consumer or commercial), product version used, country (e.g. United States, Canada, etc.), operating system, device manufacturer and the like. To accurately identify changes in respondent populations that affected the NPS, many different customer dimensions may be used. In an example, for a software program, there are more than a 150 customer dimensions. Each dimension may itself be divided into multiple levels. Changes in NPS may then be calculated for each dimension and each level. For each of those levels and/or dimensions, the portion of the NPS change that is due to changes in the user proportion may be calculated. As a result, an adjusted NPS change which is representative of the true NPS change may be calculated for each dimension and/or level. The changes in NPS (e.g., total NPS change and the adjusted NPS change) at the different dimensions may be displayed in an easily understandable UI to enable a user to review the changes at each dimension and each level. This may enable the user to easily review how the NPS actually changed for various different customer dimensions and levels.

While this may be very useful in analyzing the variables that affect an NPS changes, for enterprises that that have significant number of respondents that fall into numerous categories, it may still take a lot of time and resources to manually review how NPS changes in each dimension to determine whether or not a specific dimension caused a significant change in the total NPS. To address this problem, the technical solution identifies and presents the largest change in NPS at different dimensions and/or levels to enable the user to identify dimensions that influence the change in NPS more.

As will be understood by persons of skill in the art upon reading this disclosure, benefits and advantages provided by such implementations can include, but are not limited to, a technical solution to the technical problems of calculations of changes in customer ratings that do not take into account changes in respondent populations, identifying what changes in respondent populations may have caused changes in user ratings, and presenting the results in an easily understandable and easily navigable manner to the user. Solutions and implementations provided herein optimize the process of evaluating user rating changes and improve both the accuracy of results and the ease of use. This may enable the user to quickly and accurately identify true changes in user ratings and determine how changes in user populations may have caused changes in ratings. The benefits provided by these technology-based solutions yield more accurate and user-friendly mechanisms of analyzing user ratings, and increased system and user efficiency.

As used herein, the terms “customer,” “respondent” and “user” may refer to an individual or entity that responds to a rating survey. Furthermore, as used herein, the term “adjusted NPS change” or “true NPS change” may refer to a change in NPS that is indicative of actual changes in user ratings that is not caused by changes in sample populations.

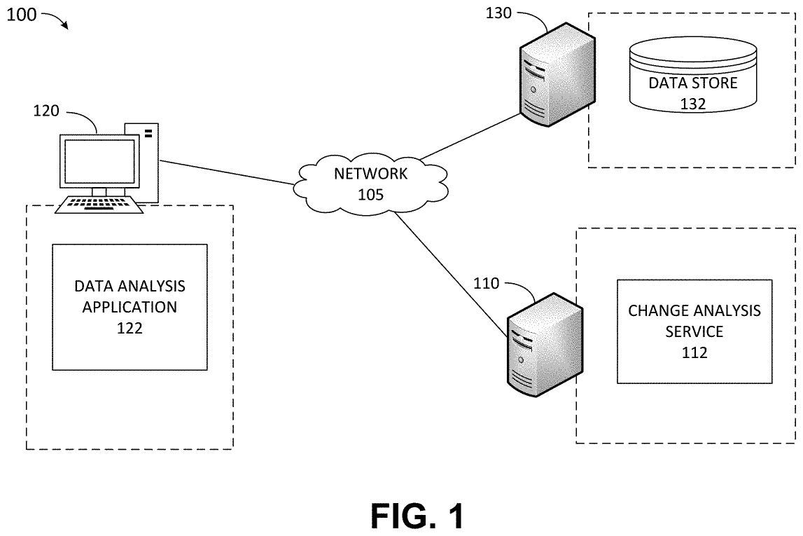

FIG. 1 illustrates an example system 100, upon which aspects of this disclosure may be implemented. The system 100 may include a server 110 which may include and/or execute a change analysis service 112 and a client device 120. The server 110 may operate as a shared resource server located at an enterprise accessible by various computer client devices such as client device 120. The server may also operate as a cloud-based server for offering global change analysis services. Although shown as one server, the server 110 may represent multiple servers for performing various different operations.

The change analysis service 112 may operate as the backend engine for performing change analysis calculations. The change analysis service 112 may operate to receive user input such as selection of two time periods (e.g., two different months), one or more additional filters, and a request to identify statistically significant changes in NPS, to calculate a change in user ratings between the two time periods for one or more dimensions and levels of user data, to detect statistically significant changes in NPS as further discussed below, and to provide the calculated results for display.

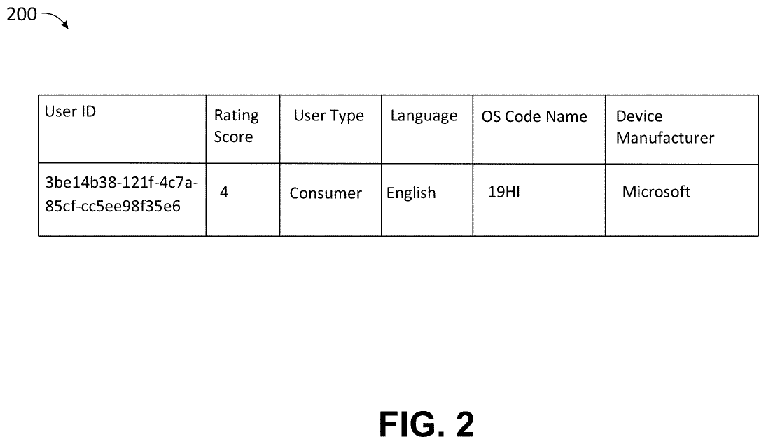

The server 110 may be connected to (e.g., via a network 105) or include a storage server 130 containing a data store 132. The data store 132 may function as a repository in which user rating data is stored. In one implementation, the data may be stored in a columnar format. The user rating data may be divided and stored separately for different time periods. For example, the data may be collected and stored in different data sheets for each month of the year or each date of the month. To ensure that respondent population changes are taken into account when calculating user rating changes, various different dimensional data may also be collected and stored, along with the user rating data, as further discussed below with respect to FIG. 2.

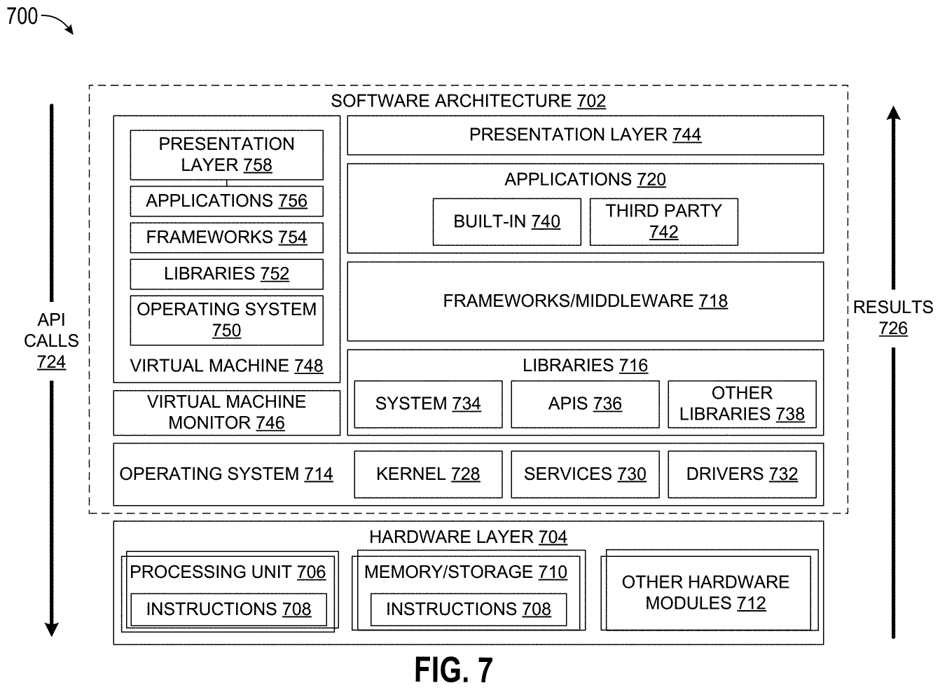

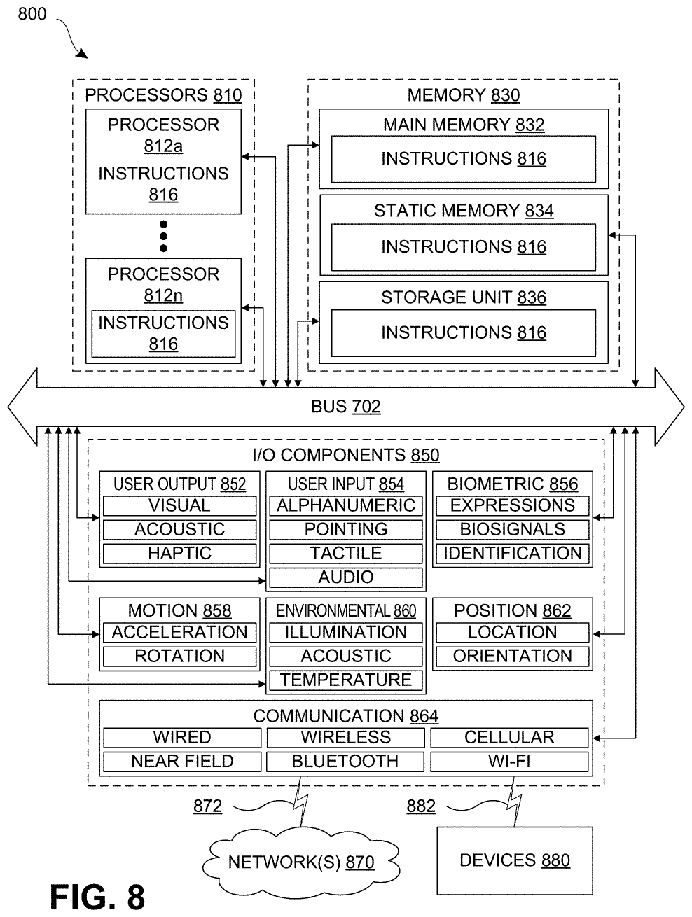

The client device 120 may be connected to the server 110 via the network 105. The network 105 may be a wired or wireless network(s) or a combination of wired and wireless networks that connect one or more elements of the system 100. The client device 120 may be a personal or handheld computing device having or being connected to input/output elements that enable a user to interact with digital content such as a data analysis application on the client device 120. Examples of suitable client devices 120 include, but are not limited to, personal computers, desktop computers, laptop computers, mobile telephones; smart phones; tablets; phablets; smart watches; wearable computers; gaming devices/computers; televisions; head-mounted display devices and the like. The internal hardware structure of a client device is discussed in greater detail in regard to FIGS. 7 and 8.

The client device 120 may include a user data analysis application 122. The user data analysis application 122 may be a computer program executed on the client device 120 that configures the device to be responsive to user input that allows a user to interactively view and/analyze user rating data such as NPS data and statistically significant changes in NPS. The user data analysis application 122 may provide a UI that allows the user to interact with user rating data stored in the data store 132 and/or on the client device 120. The user data analysis application 122 may function as a frontend application for the backend services offered by the change analysis service 112. Thus, the user data analysis application 122 may function as a tool that enables a user to select various filters to view and/or analyze specific user rating data such as the NPS. For example, the user data analysis application 122 may enable the user to select a time period 1 and a time period 2 for viewing the NPS in each of those time periods, selecting one or more additional filters (e.g., dimensions), viewing the change in NPS in between the selected time periods, requesting identification of statistically significant changes and/or for requesting display of information about the identified statistically significant changes. The user's selections may be transmitted to the change analysis service 112, where the calculations are performed. The results may be transmitted back to the client device 120 to be displayed to the user via a UI of the user data analysis application 122. The client device 120 may also provide access to a user data analysis application (not shown) stored and/or run on a server such as the server 110 and accessed via a user agent such as a browser.

FIG. 2 is an example data set used for collecting and storing NPS data in a given time period. To enable identification of statistically significant changes in user ratings, in addition to collecting and storing a respondent's rating score, additional data about the respondent may also be collected. The additional data may include information that is already available to the enterprise. For example, if the respondent is a user of a software program, the software program may have collected data about the user, the user's device, and the like, during a registration process. This data may be stored in a data store associated with and/or accessible to the enterprise and may be retrieved from such data store when the user responds to a customer survey for which changes in NPS may be calculated. It should be noted that in collecting, retrieving, storing and analyzing respondent data, care is taken to ensure the user's privacy is protected.

The retrieved respondent data may be categorized into different dimensions and stored in a columnar structure such as the data structure 200 of FIG. 2. One or more columns of the data structure 200 may represent different dimensions. One of the columns of the data structure may be used to store user IDs that differentiate the respondents from each other. The user ID may be an identification number that does not reveal any private or identifying information. The data structure 200 may also include a column for storing the rating score selected by each user. The rating score may have a predetermined range based on the parameters selected for the survey. For example, the rating score may have a range from 0 to 10. In another example, the rating score may have a range of 0 to 5. Alternatively, the rating score may have a range of 0 to 100.

To calculate the NPS, the rating scores may be categorized as promoters, passives, and detractors. In some implementations, for a rating score range of 0 to 10, promoters may be categorized as respondents that provide a score of 9-10, passives may be categorized as those that provide a score of 7-8, and detractors may be designated as those who provide a score of 1-7. The percentage of detractors may then be subtracted from the percentage of promoters to obtain the NPS.

In addition to the user ID and the rating score, the data structure 200 may include multiple additional columns, each of which may represent a separate dimension for the respondent. For example, the data structure 200 includes a user type, language, OS code name and device manufacturer. Each of these dimensions may have multiple levels. For example, the user type may have a consumer level and a commercial level, while the language level may have a separate level for every language in which the product and/or service is offered (e.g., English, Spanish, French, Chinese, and the like). Similarly, the OS code name and device manufacturer may have many different levels. Depending on the type of product, service, or company for which a survey is being conducted, many different types of dimensions may be available for retrieval and storage. Given that each of these dimensions may have numerous possible levels, the resulting data structure may be a large and complex data structure containing a significantly large amount of data categorized into numerous different dimensions and levels. As a result, manually analyzing this data to identify statistically significant changes may become considerably time-consuming and very difficult to achieve.

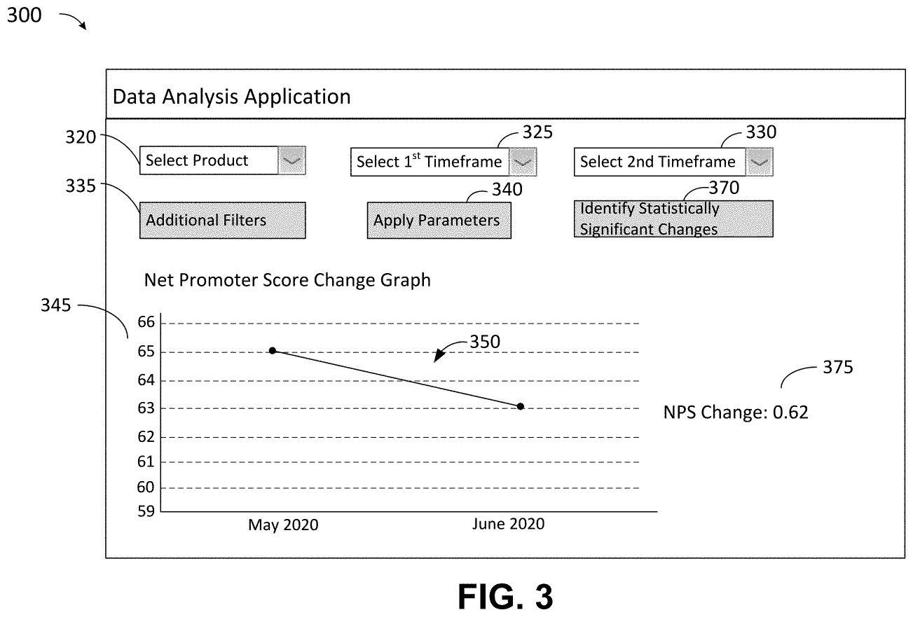

FIG. 3 is an example GUI screen 300 displayed by a data analysis application used to analyze and display customer rating data. GUI screen 300 may be a display screen of a data analysis application which can be used by an administrator of an enterprise to review and analyze customer rating data. In one implementation, the data analysis application communicates with a backend data analysis service, which may be stored in a server, to access customer rating data stored in a data store. The backend service may access the customer rating data (e.g., a data structure such as the data structure 200 of FIG. 2) and perform analyses requested by the administrator via the GUI screen 300.

It should be noted that in some implementations, all calculations are performed locally by the data analysis application. Moreover, in some implementations, the customer rating data may be stored locally on the client device on which the data analysis application is stored.

Enterprises may conduct customer surveys for multiple products or services. To enable such enterprises to review the results of the various surveys, the GUI screen 300 may include a menu option 320 for selecting the product, service or company for which the survey results will be analyzed and displayed. Furthermore, to enable selection of a specific time period for which survey results are available, a menu option 325 may be provided. When the user desires to review changes in customer ratings over time (e.g., changes in NPS), they may utilize a menu option 330 to select a second time period. When two different time periods are selected via menu options 325 and 330, the data analysis application may calculate and analyze changes in customer rating between the two time periods.

In some implementations, additional filters may be selected via the menu option 335. For example, upon selecting the menu option 335, a pop-up menu may be displayed that presents a list of additional filters (e.g., dimensions and/or levels) for selection. Once a produce, service, or company and/or additional filters have been selected and two time periods have been chosen, the menu option 340 may be used to apply the selected parameters to the customer rating data. In some implementations, the resulting calculations is displayed via a graph such as the graph 345. Alternatively, the results may be displayed via different types of diagrams. In some examples, the results may be displayed via a table. In different implementations, instead of presenting the results on the same GUI screen, the results may be displayed via a different screen (e.g., a pop-up screen). In an example, the value for calculated total NPS change may be displayed alongside the graph 345 via a UI element 365. It should be noted that the menu options 320, 325, 330, 335 and 340 are only example user interface elements for selecting parameters in performing data analysis on customer rating data. Other types of UI elements are contemplated and may be utilized.

The graph 345 may display a total NPS line 350 that depicts how the NPS changes over time from the first time period to the second time period. For the example graph 345, the NPS line 350 illustrates that the NPS changed from a value slightly above 65 to about 63 (e.g., for a rating scale of 0 to 100). Additionally, the GUI screen 300 may display a UI element 375 for providing the value for the final NPS change over the given time period. For example, the UI element 375 illustrates that from the beginning of May to the end of June, the value of NPS change is 0.62.

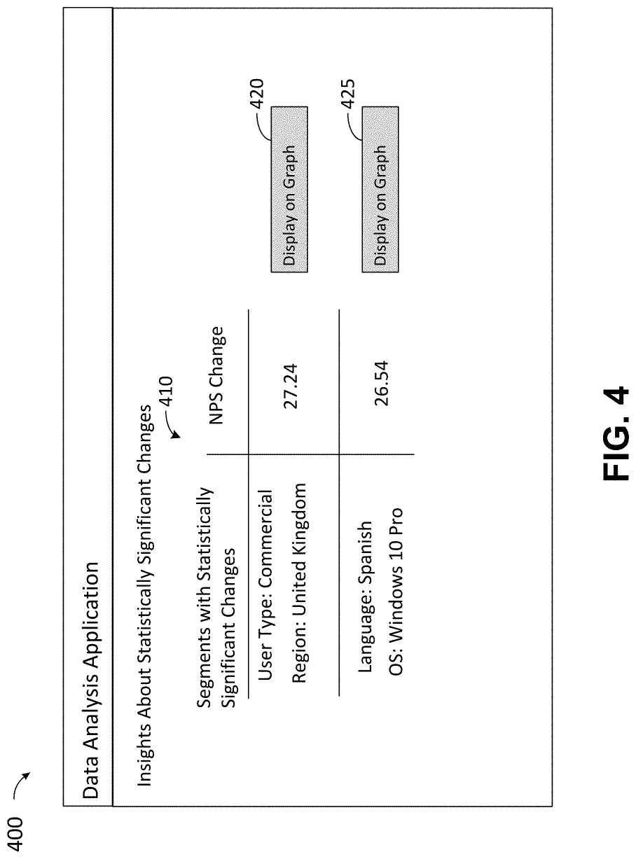

The GUI screen 300 may also include a menu option 370 for submitting a request to identify statistically significant changes in user ratings over the selected time period. In some implementations, in response to selection of the menu option 370, an additional GUI screen such as the one displayed in GUI screen 400 of FIG. 4 may be provided to display information about statistically significantly changes in user ratings that have been identified. In some implementations, the GUI screen 400 is displayed alongside the GUI screen 300 to provide side by side information and analysis. In alternative implementations, the GUI screen 400 may be displayed by itself.

The GUI screen 400 may display insights about statistically significant changes in user ratings over the selected time periods. In some implementations, the information is displayed via a data structure such as the table 410. The table 410 may include a column for displaying population segments that have been identified as showing statistically significant changes in user ratings. For example, the table 410 includes a segment consisting of a group of users that fall into the categories of commercial users from United Kingdom 400, and a group of users that fall into the category of Spanish language users that have a Windows 10 Pro operating system. The categories may display the dimension (e.g., user type, region, language, OS) and level (e.g., commercial, United Kingdom, Spanish, Windows 10 Pro) that were identified as having statistically significant changes in user ratings. In addition to the identified segments, table 410 may include a column for displaying the amount of change in user rating for the identified segments. Thus, table 410 depicts that the population segment consisting of commercial users from United Kingdom had a 27.24 NPS change which is significant change in user rating. Similarly, table 410 depicts that the population segment consisting of Spanish language users having a Windows 10 Pro operation system had a 26.54 NPS change which is also a significant change in user rating. Thus, GUI screen 400 can quickly and clearly display identified statistically significant changes in user ratings, along with the value of the NPS change. This enables the viewer to quickly identify statistically significant changes in user ratings and determine the amount of change.

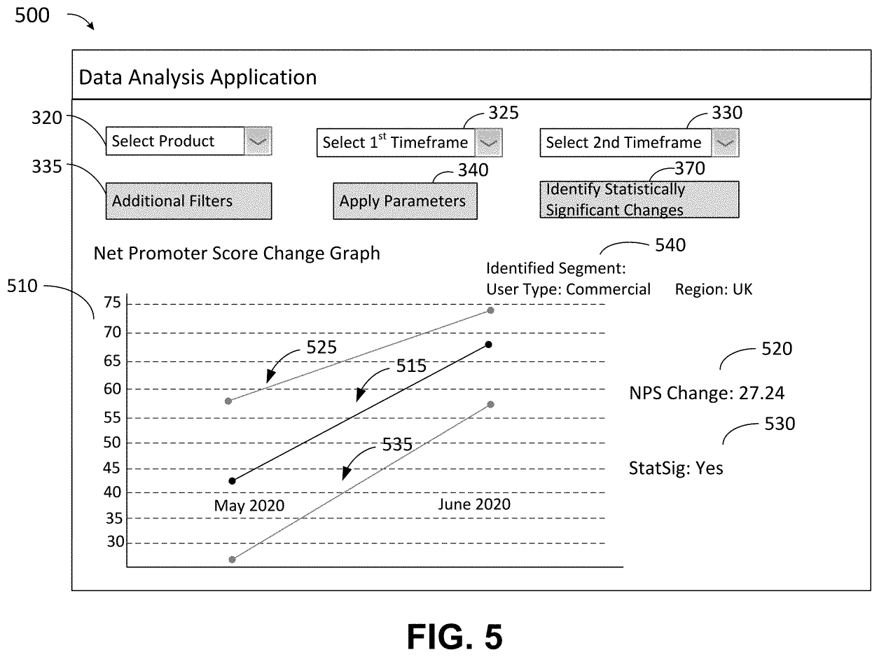

In some implementations, the GUI screen 440 also includes a menu option 420 and 425 for requesting to display the statistically significant change on a graph. In some implementations, in response to selection of the menu option 420 (or 425), an additional GUI screen such as the one displayed in GUI screen 500 of FIG. 5 may be provided to display information about the identified statistically significant change on a graphical diagram. The GUI screen 500 may be displayed by clicking on the menu option 420 or 425 in the GUI screen 400. Alternatively, the GUI screen 500 may be displayed by invoking a separate UI element. In some implementations, the GUI screen 500 is displayed alongside the GUI screen 300 to provide side by side information and analysis. In alternative implementations, the GUI screen 500 may be displayed by itself. In an implementation, where the GUI screen 400 is displayed adjacent to the GUI screen 300 of FIG. 3, selecting the menu option 420 or 425 may cause the GUI screen 300 to provide updated information. For example, the graph 345 and the UI element 375 may display updated data.

Once displayed, the GUI screen 500 may include the menu options 320, 325, 330, 335, 340 and 370, as discussed above. Alternatively, the GUI screen 500 may only include UI elements for displaying information about the identified statistically significant change. The GUI screen 500 may also include a diagram such as the graph 510 for displaying how the NPS changed for the identified segment over the selected time period. For example, graph 510 may include a line 515 that depicts how the NPS value changed from a value slightly above 40 in the beginning of May 2020 to a value above 65 at the end of June 2020. This can provide a pictorial depiction of the statistically significant change in NPS during the selected time period. To provide the graph 510, the application may apply the filters associated with the identified segments to the underlying data. For example, the application may apply the filers commercial user and UK region to the data to filter out data related to those categories. In some implementations, graph 510 may also include a line such as the line 350 of graph 345 for displaying the overall NPS change such that the user can clearly see the difference between the overall NPS change and the statistically significant NPS change. In other implementations, graph 510 may also include lines 525 and 535 for depicting the bounds of margin of error with respect to the statistically significant change in NPS. The line 525 may represent the upper limit of the statistically significant change in NPS when the margin of error is taken into account (e.g., the statistically significant change in NPS plus the margin of error), while the line 535 may display the lower limit of lower limit of the statistically significant change in NPS when the margin of error is taken into account (e.g., the statistically significant change in NPS minus the margin of error).

Additionally, the GUI screen 500 may include a UI element 520 for displaying the value for the identified NPS change, as well as a UI element 530 which provides an indication that the graph 510 displays data associated with statistically significant changes. Furthermore, the GUI screen 500 may include a UI element 540 for displaying the population segment that was identified as having a statistically significant change and for which data is being displayed in the graph 510. The UI element 540 may display the dimensions and levels that correspond to the identified statistically significant change.

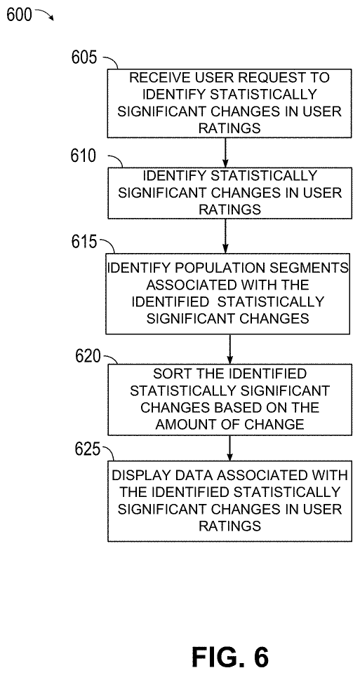

FIG. 6 is a flow diagram depicting an exemplary method 600 for identifying statistically significant changes in user ratings and displaying information about such statistically significant changes. In an example, one or more steps of method 600 may be performed by a data analysis application (e.g., data analysis application 122 of FIG. 1) and/or a change analysis service (e.g., change analysis service 112 of FIG. 1).

At 605, method 600 may begin by receiving a user request for identifying statistically significant changes in user ratings. The request may be submitted via a UI element of a data analysis application and may include one or more parameters such as the selection of a product for which survey data is available. The request may also include a selection of two time periods between which the change in ratings should be calculated. In some implementations, the request may include additional filters selected by the viewer.

Once the request is received, method 600 may proceed to use the received parameters (e.g., the requested product, and time periods) to access the data sets associated with user ratings for the requested product, service and/or company during the requested time periods. In some implementations, this involves accessing a first data set for data collected during the first time period and a second data set for data collected during the second time period.

The information in the data sets may then be used to identify statistically significant changes in user ratings during the given time periods, at 610. This may be achieved by utilizing one or more algorithms that enable efficient detection of statistically significant changes. This is because, as discussed above, data sets associated with user ratings may be complex and significantly large in size. To examine every point in data set either manually or by use of a powerful computer would be inefficient, impractical and often impossible. Thus, the technical solution makes use of a mechanism that can accurately detect statistically significant changes in user ratings efficiently.

In one implementation, this is achieved by identifying extrema values in user rating changes. Extrema values may refer to points at which a maximum or minimum value was obtained. Thus, the mechanism may examine each column of the data to identify extrema values. Once the extrema values are obtained, the change in user rating between the first period time and the second time period for those values may be calculated and compared against a margin of error. The margin of error may refer to the amount of random sampling error in the results of a survey. The margin of error may be calculated using the following equation.

MoE=Z×(σ÷\sqrt{n}) (1)

In equation (1), Z represents a selected confidence value (e.g., percentage of confidence), a is used to refer to the sample population's standard deviation and n represents the sample size. The confidence level value may be preselected based on a desired level of confidence for the algorithm. For example, the value of 2.58 may be selected when a 99 percent confidence level is desired, while the value of 1.28 may be chosen, when an 80 percent confidence level is sufficient. The confidence level may be preselected. Alternatively, the end-user may be able to select the confidence level by utilizing an UI element.

Once margin of error is calculated for the given data sets and the change in user ratings is determined for extrema values, the change may be compared against the margin of error. When the change is larger than the margin of error, the extrema value may be added to a list of potential statistically significant changes. The process may be repeated as needed to identify all potential statistically significant changes. The following is an example pseudocode that may perform the functions discussed above to identify statistically significant changes in user ratings.

```
FIND_STATSIG(DF1, DF2, PREV_FILT=[ ]):
  FOR C = Column IN UNION(DF1, DF2):
    FOR V = Value in EXTREMA(C):
      MOE = MARGIN_OF_ERROR(DF1[C == V], DF2[C == V])
      CHANGE = ABS(NPS(DF1[C==V]) − NPS(DF2[C==V]))
      IF CHANGE > MOE:
        ADD V + PREV_FILT TO RESULTS
      FIND_STATSIG(DF1[C==V], DF2[C==V], PREV_FILT+[C:V])
```

DF1 represents the data set for the first time period and DF2 represents the data set for the second time period.

The above implementation identifies statistically significant changes in user ratings by utilizing a binary tree mechanism. Such a mechanism is still exponential. However, it is much more efficient than examining every data point, as the total number of combinations may be two to the power of the number of filters applied. Because the majority of actionable results may be identified within four to five filter applications, the overall number of data points examined remains reasonably low. Thus, the results may be identified quickly and by using significantly smaller processing and memory resources.

While the above discussed mechanism for identifying statistically significant changes in user ratings is much more efficient than previously available approaches, the level of accuracy of the process can be further improved. That is because, the mechanism only examines extrema data points. As a result, it may not identify some data points that are not necessarily extrema. For example, when the mechanism is only examining dimensions that have extrema points, it may overlook statistically significant data points in a dimension that does not include extrema points.

In an alternative implementation, instead of identifying and examining extrema data points, the mechanism may first rank and sort the segments based on their likelihood of being statistically significant, and then selecting a specific number of most likely results to recursively apply the algorithm. This may involve first calculating a margin of error for the given data sets, as discussed above. Next, the absolute value of the change in user ratings for a given data point between the first time period and the second time period may be calculated. Once those values are computed, the absolute value of the change in user ratings may be divided by the margin of error. The resulting values may then be flattened and subsequently sorted. In this manner, the mechanism takes a horizontal pass at each level in the tree instead of examining every point. The following is an example pseudocode that may perform the functions discussed above.

```
STATSIGNESS(DF1, DF2):
  FOR C = Column IN UNION(DF1, DF2):
    FOR V = Value in C:
    MOE = MARGIN_OF_ERROR(DF1[C == V], DF2[C == V])
    CHANGE = ABS(NPS(DF1[C==V]) − NPS(DF2[C==V]))
    RESULTS[C, V] = [CHANGE / MOE, C, V]
FLAT(RESULTS)
SORT(RESULTS)
RETURN RESULTS
```

The STATSIGNESS function may then be used to identify the most likely statistically significant data points by examining the next N most likely results (e.g., results that are most likely determined as CHANGE/MOE) recursively. This enables the use of the variable N as a control function to change the complexity of the algorithm. By increasing N, the accuracy of the results may be increased which may also increase the complexity of the calculations. Similarly, by decreasing N, the complexity may be decreased. The following is an example pseudocode that may perform these functions.

```
FIND_STATSIG(DF1, DF2, PREV_FILT=[ ], N=5, MAX_DEPTH=5):
  OPTIONAL: Stop if LEN(PREV_FILT) >= MAX_DEPTH
  S = STATSIGNESS(DF1, DF2)
  ADD S.FILTER(S > 1) TO FINAL STATSIG RESULTS
  FOR (TOP N) AS K FROM S:
    FIND_STATSIG(DF1[K[1] == K[2]], DF2[K[1] == K[2]], [K], N)
```

The above algorithm first selects all results that are larger than 1 as statistically significant results. Then from the remaining results, the algorithm selects the next N top results as the most likely results for being statistically significant. As a result, the next N top results are also kept for the next iteration. This is applied recursively to identify the most statistically significant results. The number of times the process is repeated can be set by using the value MAX_DEPTH. Thus, the process in the above example pseudocode is repeated 5 times. Other values may be selected, as needed. This enables that use of the variables N and MAX_DEPTH as indicators for the complexity of the algorithm. In the example above, the value of N is selected as 5. Other values may be selected as desired. The values of N and MAX_DEPTH may be preset in the data analysis application or may be selectable by the end-user via a UI element. The complexity of this algorithm is proportional to the variables N and MAX_DEPTH and to the number of unique values (e.g., unique dimensions and levels). This results in a polynomial time algorithm which can be performed much more efficiently. Furthermore, the algorithm achieves high accuracy. In an example, the algorithm detected approximately 98.56% of statistically significant changes in user rating with an N value of 5.

Once statistically significant changes in user rating are identified, the dimensions and levels (e.g., filter combinations) that correspond with the identified statistically significant changes in user rating may be determined, at 615. Thus, for example, method 600 may identify that the statistically significant change is associated with the commercial user type in the United Kingdom. Thus, the method 600 may receive two data sets as an input and may provide two dimensions and levels along with the corresponding change in user rating as an output.

The identified statistically significant changes in user rating may then be sorted, at 620. In some implementations, the identified statistically significant changes in user rating are sorted based on the value of the change in user rating (e.g., change in NPS). Thus, those statistically significant changes having higher changes in NPS may be placed at a higher level in the list of identified statistically significant changes.

Once the calculations are performed and the dimensions and/or levels are sorted, display data associated with the identified statistically significant changes in user rating may be provided for display to the end-user, at 625. This may be achieved, for example, by transmitting display data containing information about the identified statistically significant changes in user rating and then displaying a diagram such as the one depicted in FIG. 3 or by displaying a GUI screen such as the one displayed in FIG. 4. Additional information may be provided for display as requested by the viewer.

FIG. 7 is a block diagram 700 illustrating an example software architecture 702, various portions of which may be used in conjunction with various hardware architectures herein described, which may implement any of the above-described features. FIG. 7 is a non-limiting example of a software architecture and it will be appreciated that many other architectures may be implemented to facilitate the functionality described herein. The software architecture 702 may execute on hardware such as client devices, native application provider, web servers, server clusters, external services, and other servers. A representative hardware layer 704 includes a processing unit 706 and associated executable instructions 708. The executable instructions 708 represent executable instructions of the software architecture 702, including implementation of the methods, modules and so forth described herein.

The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular system. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine depicted in block diagram 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement methods or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860 and/or position components 862, among a wide array of other environmental sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 862 may include, for example, location sensors (for example, a Global Position System (GPS) receiver), altitude sensors (for example, an air pressure sensor from which altitude may be derived), and/or orientation sensors (for example, magnetometers). The motion components 858 may include, for example, motion sensors such as acceleration and rotation sensors. The environmental components 860 may include, for example, illumination sensors, acoustic sensors and/or temperature sensors.

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 862, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-5) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:
Item 1. data processing system comprising:
a processor; and
a memory in communication with the processor, the memory comprising executable instructions that, when executed by the processor, cause the data processing system to perform functions of:
receiving a request to identify a statistically significant change in a parameter associated with changes in user ratings between a first time period and a second time period;
retrieving data from a first data structure associated with the user ratings during the first time period and a second data structure associated with the user ratings during the second time period, each of the first and the second data structures including a plurality of dimensions for each user rating and each dimension having one or more levels;
identifying, based on the retrieved data, the statistically significant change in the parameter associated with the user ratings between the first time period and the second time period;
identifying at least a dimension and a level associated with the identified statistically significant change; and
providing display data for generating a user interface (UI) screen to display information about the identified statistically significant change,
wherein identifying the statistically significant change in the parameter associated with the user ratings between the first time period and the second time period includes:
   receiving, as an input, the first data structure, the second data structure and an integer number associated with a complexity level of calculations,
   calculating a margin of error for the first data structure and the second data structure,
   calculating the parameter associated with the changes in user ratings,
   identifying one or more results based on the parameter or the margin of error,
   sorting the one or more results,
   selecting statistically significant results from the sorted one or more results, resulting in a list of one or more remaining results,
   selecting the integer number of results from a top of the one or more remaining results, and
   repeating the selecting steps for a predetermined number of times.
Item 2. The data processing system of item 1, wherein the instructions further cause the processor to cause the data processing system to perform functions of:
   receiving a request to display data related to the identified statistically significant change on a graphical diagram, and
   upon receiving the request, presenting the graphical diagram displaying changes in the identified statistically significant change between the first time period and the second time period.
Item 3. The data processing system of item 2, wherein the graphical diagram displays at least one of the identified dimension and the identified level.
Item 4. The data processing system of any one of the preceding items, wherein the integer number associated with a complexity level of calculations is selected by an end-user.
Item 5. The data processing system of any one of the preceding items, wherein the parameter associated with the user ratings is a Net Promotor Score (NPS).
Item 6. The data processing system of any one of the preceding items, wherein the instructions further cause the processor to cause the data processing system to perform functions of:
   identifying a plurality of statistically significant changes in the parameter associated with the user ratings between the first time period and the second time period; and
   sorting the identified plurality of statistically significant changes based on an a value of the parameter.
Item 7. The data processing system of any one of the preceding items, wherein the displayed information about the identified statistically significant change includes at least one of the identified dimension, the identified level and the parameter for the identified dimension and the identified level.
Item 8. A method for identifying statistically significant changes in user ratings, comprising:
   receiving a request to identify a statistically significant change in a parameter associated with changes in user ratings between a first time period and a second time period;
   retrieving data from a first data structure associated with the user ratings during the first time period and a second data structure associated with the user ratings during the second time period, each of the first and the second data structures including a plurality of dimensions for each user rating and each dimension having one or more levels;
   identifying, based on the retrieved data, the statistically significant change in the parameter associated with the user ratings between the first time period and the second time period;
   identifying at least a dimension and a level associated with the identified statistically significant change; and
   providing display data for generating a user interface (UI) screen to display information about the identified statistically significant change,
   wherein identifying the statistically significant change in the parameter associated with the user ratings between the first time period and the second time period includes:
      receiving, as an input, the first data structure, the second data structure and an integer number associated with a complexity level of calculations,
      calculating a margin of error for the first data structure and the second data structure,
      calculating the parameter associated with the changes in user ratings,
      identifying one or more results based on the parameter or the margin of error,
      sorting the one or more results,
      selecting statistically significant results from the sorted one or more results, resulting in a list of one or more remaining results,
      selecting the integer number of results from a top of the one or more remaining results, and
      repeating the selecting steps for a predetermined number of times.
Item 9. The method of item 8, further comprising:
   receiving a request to display data related to the identified statistically significant change on a graphical diagram, and
   upon receiving the request, presenting the graphical diagram displaying changes in the identified statistically significant change between the first time period and the second time period.
Item 10. The method of any one of items 8 or 9, wherein the integer number associated with a complexity level of calculations is selected by an end-user.
Item 11. The method of any one of items 8-10, wherein the parameter associated with the user ratings is a Net Promotor Score (NPS).
Item 12. The method of any one of items 8-11, further comprising:
   identifying a plurality of statistically significant changes in the parameter associated with the user ratings between the first time period and the second time period; and
   sorting the identified plurality of statistically significant changes based on an a value of the parameter.
Item 13. The method of any one of items 8-12, wherein the display information about the identified statistically significant change includes at least one of the identified dimension, the identified level and the parameter for the identified dimension and the identified level.
Item 14. A non-transitory computer readable medium on which are stored instructions that, when executed, cause a programmable device to:
   receive a request to identify a statistically significant change in a parameter associated with changes in user ratings between a first time period and a second time period;
   retrieve data from a first data structure associated with the user ratings during the first time period and a second data structure associated with the user ratings during the second time period, each of the first and the second data structures including a plurality of dimensions for each user rating and each dimension having one or more levels;
   identify, based on the retrieved data, the statistically significant change in the parameter associated with the user ratings between the first time period and the second time period;
   identify at least a dimension and a level associated with the identified statistically significant change; and
   provide display data for generating a user interface (UI) screen to display information about the identified statistically significant change,
   wherein identifying the statistically significant change in the parameter associated with the user ratings between the first time period and the second time period includes:
      receiving as an input the first data structure, the second data structure and an integer number associated with a complexity level of calculations,
      calculating a margin of error for the first data structure and the second data structure,
      calculating the parameter associated with the changes in user ratings,
      identifying one or more results based on the parameter or the margin of error,
      sorting the one or more results,
      selecting statistically significant results from the sorted one or more results, resulting in a list of one or more remaining results,
      selecting the integer number of results from a top of the list of one or more remaining results, and
      repeating the selecting steps for the selected one or more results.
Item 15. The non-transitory computer readable medium of item 14, wherein the instructions further cause the programmable device to:
   receiving a request to display data related to the identified statistically significant change on a graphical diagram, and
   upon receiving the request, presenting the graphical diagram displaying changes in the identified statistically significant change between the first time period and the second time period.
Item 16. The non-transitory computer readable medium of any one of items 14 or 15, wherein the integer number associated with a complexity level of calculations is selected by an end-user.
Item 17. The non-transitory computer readable medium of any one of items 14-16, wherein the parameter associated with the user ratings is a Net Promotor Score (NPS).
Item 18. The non-transitory computer readable medium of any one of items 14-17, wherein the instructions further cause the programmable device to:
   identifying a plurality of statistically significant changes in the parameter associated with the user ratings between the first time period and the second time period; and
   sorting the identified plurality of d statistically significant changes based on an a value of the parameter.
Item 19. The non-transitory computer readable medium of any one of items 14-18, wherein the display information about the identified statistically significant change includes at least one of the identified dimension, the identified level and the parameter for the identified dimension and the identified level.
Item 20. The non-transitory computer readable medium of any one of items 14-19, wherein the margin of error is calculated based on a user provided confidence level

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

1. A data processing system comprising:
a processor; and
a memory in communication with the processor, the memory comprising executable instructions that, when executed by the processor, cause the data processing system to perform functions of:
receiving, via a first user interface (UI) element of a first UI screen, a user request to identify a statistically significant change in a parameter associated with changes in user ratings between a first time period and a second time period, the statistically significant change in the parameter being a change that is not likely to have occurred as a result of sampling error alone;
retrieving data from a first data structure associated with the user ratings during the first time period and a second data structure associated with the user ratings during the second time period, each of the first and the second data structures including a plurality of data entries for the user ratings, a plurality of dimensions for each of the plurality of user ratings and each dimension having one or more levels;
identifying, by the processor, based on the retrieved data, the statistically significant change in the parameter between the first time period and the second time period;
identifying at least a dimension and a level associated with the identified statistically significant change; and
generating display data by the processor, for a second UI screen to display information about the identified statistically significant change, the second UI screen including a second UI element for displaying a population segment with the identified statistically significant change and a third UI element for displaying the identified statistically significant change for the population segment,
wherein identifying the statistically significant change in the parameter associated with the changes in user ratings between the first time period and the second time period includes:
receiving, as an input, the first data structure, the second data structure and an integer number associated with a desired complexity level of calculations,
calculating a margin of error for the first data structure and the second data structure,
calculating the parameter associated with the changes in user ratings for two or more of the plurality of data entries,
identifying one or more results, from among the calculated two or more parameters based the margin of error,
sorting the one or more results,
selecting statistically significant results from the sorted one or more results to generate a list of one or more remaining results,
selecting the integer number of results from a top of the one or more remaining results, and
repeating the selecting steps for a predetermined number of times to identify the statistically significant change in the parameter.

2. The data processing system of claim 1, wherein the instructions further cause the processor to cause the data processing system to perform functions of:
receiving a request to display data related to the identified statistically significant change on a graphical diagram, and
upon receiving the request, presenting the graphical diagram displaying changes in the identified statistically significant change between the first time period and the second time period.

3. The data processing system of claim 2, wherein the graphical diagram displays at least one of the identified dimension and the identified level.

4. The data processing system of claim 1, wherein the integer number associated with the desired complexity level of calculations is selected by an end-user.

5. The data processing system of claim 1, wherein the parameter associated with changes in the user ratings is a Net Promotor Score (NPS).

6. The data processing system of claim 1, wherein the instructions further cause the processor to cause the data processing system to perform functions of:
identifying a plurality of statistically significant changes in the parameter associated with changes in the user ratings between the first time period and the second time period; and
sorting the identified plurality of statistically significant changes based on an a value of the parameter.

7. The data processing system of claim 1, wherein the displayed information about the identified statistically significant change includes at least one of the identified dimension, the identified level and the parameter for the identified dimension and the identified level.

8. A method for identifying statistically significant changes in user ratings, comprising:
receiving, via a first user interface (UI) element of a first UI screen, a user request to identify a statistically significant change in a parameter associated with changes in user ratings between a first time period and a second time period, the statistically significant change in the parameter being a change that is not likely to have occurred as a result of sampling error alone;
retrieving data from a first data structure associated with the user ratings during the first time period and a second data structure associated with the user ratings during the second time period, each of the first and the second data structures including a plurality of data entries for the user ratings, a plurality of dimensions for each of the plurality of user ratings and each dimension having one or more levels;
identifying, by the processor, based on the retrieved data, the statistically significant change in the parameter between the first time period and the second time period;
identifying at least a dimension and a level associated with the identified statistically significant change; and
generating display data by the processor, for a second UI screen to display information about the identified statistically significant change, the second UI screen including a second UI element for displaying a population segment with the identified statistically significant change and a third UI element for displaying the identified statistically significant change for the population segment,
wherein identifying the statistically significant change in the parameter associated with the changes in user ratings between the first time period and the second time period includes:
receiving, as an input, the first data structure, the second data structure and an integer number associated with a desired complexity level of calculations,
calculating a margin of error for the first data structure and the second data structure,
calculating the parameter associated with the changes in user ratings for two or more of the plurality of data entries,
identifying one or more results, from among the calculated two or more parameters based the margin of error,
sorting the one or more results,
selecting statistically significant results from the sorted one or more results to generate a list of one or more remaining results,
selecting the integer number of results from a top of the one or more remaining results, and
repeating the selecting steps for a predetermined number of times to identify the statistically significant change in the parameter.

9. The method of claim 8, further comprising:
receiving a request to display data related to the identified statistically significant change on a graphical diagram, and
upon receiving the request, presenting the graphical diagram displaying changes in the identified statistically significant change between the first time period and the second time period.

10. The method of claim 8, wherein the integer number associated with the desired complexity level of calculations is selected by an end-user.

11. The method of claim 8, wherein the parameter associated with changes in the user ratings is a Net Promotor Score (NPS).

12. The method of claim 8, further comprising:
identifying a plurality of statistically significant changes in the parameter associated with changes in the user ratings between the first time period and the second time period; and
sorting the identified plurality of statistically significant changes based on an a value of the parameter.

13. The method of claim 8, wherein the display information about the identified statistically significant change includes at least one of the identified dimension, the identified level and the parameter for the identified dimension and the identified level.

14. A non-transitory computer readable medium on which are stored instructions that, when executed, cause a programmable device to:
receive a request to identify a statistically significant change in a parameter associated with changes in user ratings between a first time period and a second time period;
retrieve data from a first data structure associated with the user ratings during the first time period and a second data structure associated with the user ratings during the second time period, each of the first and the second data structures including a plurality of dimensions for each user rating and each dimension having one or more levels;
identify, based on the retrieved data, the statistically significant change in the parameter associated with the user ratings between the first time period and the second time period;
identify at least a dimension and a level associated with the identified statistically significant change; and
provide display data for generating a user interface (UI) screen to display information about the identified statistically significant change,
wherein identifying the statistically significant change in the parameter associated with the user ratings between the first time period and the second time period includes:
receiving as an input the first data structure, the second data structure and an integer number associated with a complexity level of calculations,
calculating a margin of error for the first data structure and the second data structure,
calculating the parameter associated with the changes in user ratings,
identifying one or more results based on the parameter or the margin of error,
sorting the one or more results,
selecting statistically significant results from the sorted one or more results, resulting in a list of one or more remaining results,
selecting the integer number of results from a top of the list of one or more remaining results, and
repeating the selecting steps for the selected one or more results.

15. The non-transitory computer readable medium of claim 14, wherein the instructions further cause the programmable device to:
receiving a request to display data related to the identified statistically significant change on a graphical diagram, and
upon receiving the request, presenting the graphical diagram displaying changes in the identified statistically significant change between the first time period and the second time period.

16. The non-transitory computer readable medium of claim 14, wherein the integer number associated with the desired complexity level of calculations is selected by an end-user.

17. The non-transitory computer readable medium of claim 14, wherein the parameter associated with changes in the user ratings is a Net Promotor Score (NPS).

18. The non-transitory computer readable medium of claim 14, wherein the instructions further cause the programmable device to:
identifying a plurality of statistically significant changes in the parameter associated with changes in the user ratings between the first time period and the second time period; and
sorting the identified plurality of d statistically significant changes based on an a value of the parameter.

19. The non-transitory computer readable medium of claim 14, wherein the display information about the identified statistically significant change includes at least one of the identified dimension, the identified level and the parameter for the identified dimension and the identified level.

20. The non-transitory computer readable medium of claim 14, wherein the margin of error is calculated based on a user provided confidence level.
